(19) United States
(12) Patent Application Publication
(10) Pub. No.: US 2025/0379692 A1
(43) Pub. Date: Dec. 11, 2025

(54) PDP MERGING METHOD AND DEVICE IN WIRELESS COMMUNICATION SYSTEM

(71) Applicant: SAMSUNG ELECTRONICS CO., LTD., Suwon-si (KR)

(72) Inventors: Hyun jae PARK, Suwon-si (KR); Yookeun KANG, Suwon-si (KR); Ki-Ho KIL, Suwon-si (KR)

(73) Assignee: SAMSUNG ELECTRONICS CO., LTD., Suwon-si (KR)

(21) Appl. No.: 19/224,022

(22) Filed: May 30, 2025

(30) Foreign Application Priority Data
Jun. 7, 2024 (KR) 10-2024-0074559

(51) Int. Cl. H04L 5/00; H04L 25/02; H04L 27/26

(52) U.S. Cl. CPC H04L 5/0048; H04L 5/0053; H04L 25/0202; H04L 27/26526

(57) ABSTRACT

A method performed by user equipment in a wireless communication system includes receiving a plurality of reference signals from a base station, estimating a power delay profile (PDP) corresponding to each of the plurality of reference signals, and merging the PDPs corresponding to at least two reference signals, having a quasi-co-location (QCL) relationship, among the plurality of reference signals.

### CROSS-REFERENCE TO RELATED APPLICATION(S)

This U.S. non-provisional application is based on and claims priority under 35 USC § 119 to Korean Patent Application No. 10-2024-0074559, filed on Jun. 7, 2024, in the Korean Intellectual Property Office, the disclosure of which is herein incorporated by reference in its entirety.

### BACKGROUND

### 1. Field

The disclosure relates to a device and a method for merging power delay profiles (PDPs) in a wireless communication system.

### 2. Description of Related Art

In 5^{th} generation (5G) new-radio (NR) mobile communication technology, wide frequency bands to achieve a high data transmission rate and enable new services are defined. In addition, the 5G NR mobile communication technology may be implemented not only in sub-6 GHz bands such as 3.5 GHz, but also in ultrahigh-frequency bands (above 6 GHz), known as millimeter wave (mm Wave) bands such as 28 GHz and 39 GHz.

In NR wireless communication systems, channel estimation performance at user equipment significantly affects overall data throughput. Channel estimation may be based on various reference signals supported by NR. However, due to the characteristics of NR wireless communication systems, reference signals that are always present in time/frequency resources are absent, so that guaranteeing channel estimation performance based on environments may be required.

### SUMMARY

One or more aspects of the disclosure provide a device and a power delay profile (PDP) merging method for merging a power delay profile of reference signals.

According to an aspect of the disclosure, there is provided a method performed by a user equipment in a wireless communication system, the method including: receiving a plurality of reference signals from a base station; estimating a plurality of power delay profiles (PDPs), each of the plurality of PDPs respectively corresponding to one of the plurality of reference signals; and obtaining a merged PDP by merging at least two PDPs, among the plurality of PDPs, the at least two PDPs corresponding to at least two reference signals, having a quasi-co-location (QCL) relationship, among the plurality of reference signals.

According to another aspect of the disclosure, there is provided a device of a wireless communication system, the device including: at least one transceiver; at least one processor electrically connected to the at least one transceiver; and a memory electrically connected to the at least one processor and configured to store at least one instruction, wherein, when executed by the at least one processor, the at least one instruction is configured to control the device to: receive a plurality of reference signals from a base station through the at least one transceiver; estimate a plurality of power delay profiles (PDPs), each of the plurality of PDPs respectively corresponding to one of the plurality of reference signals; and obtain a merged PDP by merging at least two PDPs, among the plurality of PDPs, the at least two PDPs corresponding to at least two reference signals, having a quasi-co-location (QCL) relationship, among the plurality of reference signals.

According to another aspect of the disclosure, there is provided a wireless communication device, the device including: at least one transceiver; at least one processor electrically connected to the at least one transceiver; and a memory electrically connected to the at least one processor and configured to store at least one instruction, wherein, when executed by the at least one processor, the at least one instruction is configured to control the device to: receive a plurality of reference signals from a base station through the at least one transceiver; estimate a plurality of power delay profiles (PDPs), each of the plurality of PDPs respectively corresponding to one of the plurality of reference signals; and obtaining a merged PDP by merging at least two PDPs, among the plurality of PDPs, at least two PDPs corresponding to at least two reference signals, having a quasi-co-location (QCL) relationship, among the plurality of reference signals, and wherein the merging the PDPs includes adjusting a sample resolution ratio of at least a portion of the least two reference signals based on sample resolution ratios of the at least two reference signals being different from each other.

### BRIEF DESCRIPTION OF DRAWINGS

FIG. 1 is a diagram illustrating a wireless communication system according to one or more example embodiments.

FIG. 2 is a diagram illustrating a resource grid in a wireless communication system according to one or more example embodiments.

FIG. 3 is a diagram illustrating a synchronization signal block (SSB) structure in a wireless communication system according to one or more example embodiments.

FIG. 4 is a diagram illustrating PBCH-DMRS mapping according to one or more example embodiments.

FIG. 5 is a diagram illustrating a channel state information reference signal (CSI-RS) mapping table according to one or more example embodiments.

FIG. 6 is a diagram illustrating a CSI-RS RE mapping according to one or more example embodiments.

FIG. 7 is a diagram illustrating a RE pattern of a tracking reference signal (TRS) according to one or more example embodiments.

FIG. 8 is a diagram illustrating resource specifications of reference signals according to one or more example embodiments.

FIG. 9 is a diagram illustrating a comparison of sample resolutions between reference signal resources according to one or more example embodiments.

FIG. 10 is a diagram illustrating a comparison of overall power delay profile (PDP) ratios between reference signals according to one or more example embodiments.

FIG. 11 is a flowchart illustrating a method according to one or more example embodiments.

FIG. 12 is a diagram illustrating PDP merging according to one or more example embodiments.

FIGS. 13 to 15 are diagrams illustrating an example of the PDP merging of FIG. 12.

FIG. 16 is a flowchart illustrating a method of operating a wireless communication system according to one or more example embodiments.

FIG. 17 is a flowchart illustrating a method of operating user equipment according to one or more example embodiments.

FIG. 18 is a block diagram of a device according to one or more example embodiments.

### DETAILED DESCRIPTION

Hereinafter, example embodiments will be described with reference to the accompanying drawings. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

In the following, example embodiments will be described based on an NR network-based wireless communication system, for example, 3^{rd} Generation Partnership Project (3GPP) Release. However, example embodiments are not limited to the NR network, and may be applied to other wireless communication systems, including cellular systems such as long term evolution (LTE), LTE-advanced (LTE-A), wireless broadband (WiBro), global system for mobile communication (GSM), and next-generation communications such as 6G, as well as short-range communication systems such as Bluetooth and near field communication (NFC).

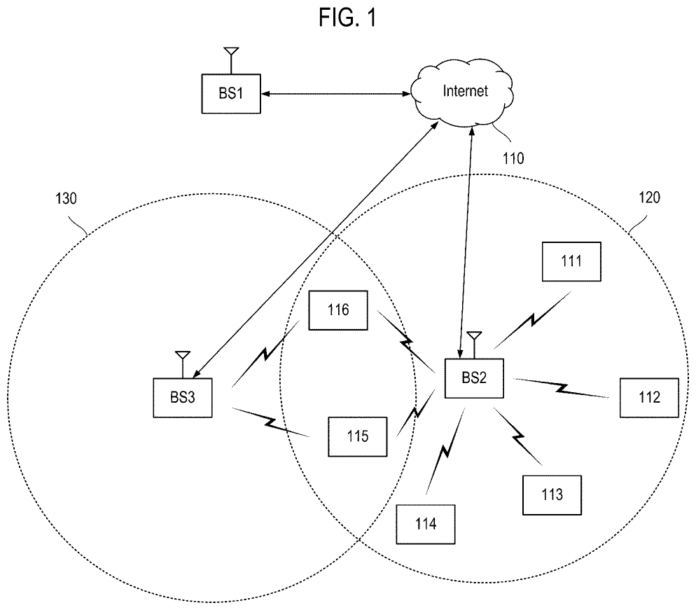

FIG. 1 is a diagram illustrating a wireless communication system according to one or more example embodiments.

Referring to FIG. 1, the wireless communication system may include, but is not limited to, a first base station BS1, a second base station BS2, and a third base station BS3. The first base station BS1 may communicate with the second base station BS2 and the third base station BS3. In addition, the first base station BS1 may communicate with at least one network 110. For example, the network 110 may include, but is not limited to, the Internet, a dedicated Internet Protocol (IP) network, or another data network.

The second base station BS2 may provide a wireless broadband access to the network 110 for a first plurality of user equipments located within a coverage area 120 of the second base station BS2. The first plurality of user equipments may include, but is not limited to, a first user equipment 111, a second user equipment 112, a third user equipment 113, a fourth user equipment 114, a fifth user equipment 115, and a sixth user equipment 116. The first user equipment 111 may be located in a small and medium-sized enterprise, the second user equipment 112 may be located in a large enterprise, the third user equipment 113 may be located in a Wi-Fi hotspot, the fourth user equipment 114 may be located in a first residential area, the fifth user equipment 115 may be located in a second residential area, and the sixth user equipment 116 may be a mobile device such as a mobile phone, a wireless laptop computer, or a wireless personal digital assistant (PDA). The third base station BS3 may provide a wireless broadband access to the network 110 for a second plurality of user equipments located within a coverage area 130 of the third base station BS3. The second plurality of user equipments may include user equipment 115 and user equipment 116. In some embodiments, one or more of the base stations BS1, BS2 and BS3 may communicate with each other and with the user equipments 111 to 116 using 6G, 5G, LTE, LTE-A, WiMAX, Wi-Fi, or other wireless communication technologies.

According to various embodiments, depending on the type of the network, the terms “base station” or “BS” may refer to a component (or a set of components) configured to provide a wireless access to a network, such as a transmission point (TP), a transmission reception point (TRP), an enhanced (eNodeB or eNB), a 5G base station (gNB), a macrocell, a femtocell, a Wi-Fi access point (AP), or other wireless-enabled devices. The base station may provide a wireless access based on one or more wireless communication protocols, such as radio interface/access NR of 6G or 5G, LTE, LTE-A, high speed packet access (HSPA), Wi-Fi 802.11a/b/g/n/ac, or the like. For ease of description, the terms “base station BS” and “TRP” are interchangeably used herein to refer to network infrastructure that provides a wireless access to a remote terminal.

According to various embodiments, depending on the network type, the terms “terminal” and “user equipment (UE)” may refer to any component such as a “mobile station,” “subscriber station,” “remote terminal,” “wireless terminal,” “receiving point,” or “user device.” For ease of description, the terms “terminal” and “user equipment” are used herein to refer to remote wireless equipment that wirelessly accesses a BS, regardless of whether the user equipment is a mobile device (for example, a mobile phone or a smartphone) or a generally considered stationary device (for example, a desktop computer or vending machine).

In FIG. 1, dashed lines indicate approximate ranges of the coverage areas 120 and 130 represented by approximate circular shapes for illustrative and explanatory purposes only. It will be clearly understood that coverage areas associated with base stations, such as the coverage areas 120 and 130, may have other shapes including irregular shapes depending on the configuration of the base stations and changes in the radio environment related to natural and artificial obstacles.

As described in more detail below, in some embodiments, one or more of the first to sixth user equipments 111 to 116 may include circuitry, software code, programming, or a combination thereof for implementing a method and a device for merging power delay profiles (PDPs) of reference signals in a wireless communication system. Also, in some embodiments, one or more of the base stations BS1 to BS3 may include circuitry, programming, or a combination thereof for a method and a device for merging PDPs of reference signals in a wireless communication system.

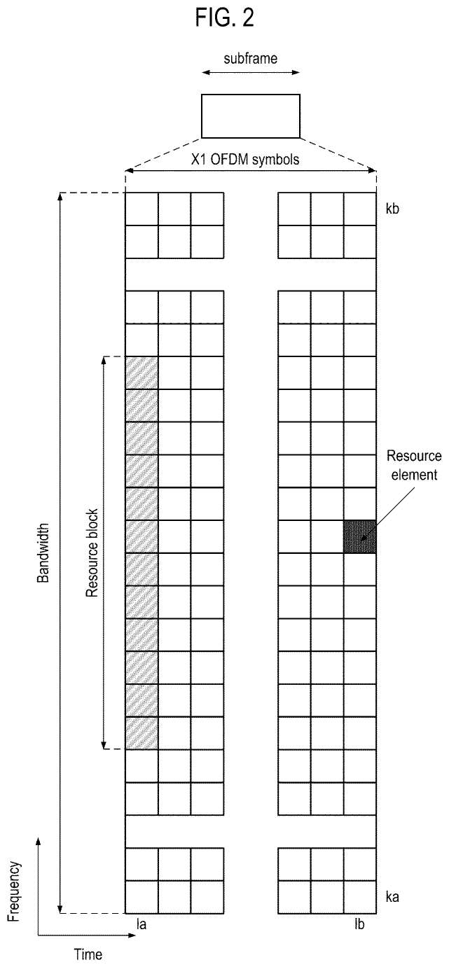

FIG. 2 is a diagram illustrating a resource grid in a wireless communication system according to one or more example embodiments.

Referring to FIG. 2, a basic unit of resource in time and frequency domains is a resource element RE. The resource element RE may be defined as a single orthogonal frequency division multiplexing (OFDM) symbol on a time axis and a single subcarrier (sc) on a frequency axis. In the frequency domain,

$${N}_{sc}^{RB}$$

consecutive OFDM symbols may constitute a single resource block RB, where Nis an integer. Also, X1

$$( where X 1 = {N}_{symb}^{slot} )$$

consecutive OFDM symbols in the time domain may constitute a single subframe.

For a single subframe, a time domain index la of a first OFDM symbol is 0 and a time domain index lb of the last OFDM symbol is 14·2^{μ}−1 (where u is a subcarrier spacing setting value). For a single bandwidth, a frequency domain index ka of a first RE is 0 and a frequency domain index kb of a last RE is

$${N}_{grid , x}^{size , μ} {N}_{sc}^{RB} - 1$$

(where

$${N}_{grid , x}^{size , μ} {N}_{sc}^{RB}$$

is a size of a carrier bandwidth for a subscript x and μ).

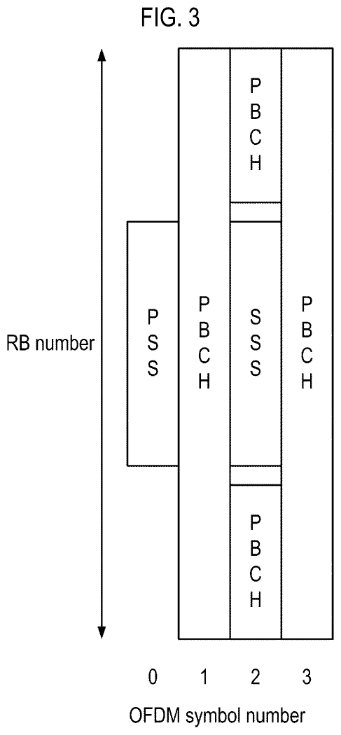

FIG. 3 is a diagram illustrating a synchronization signal block (SSB) structure in a wireless communication system according to one or more example embodiments. However, the SSB structure illustrated in FIG. 3 is only an example, and the scope of the disclosure is not limited thereto.

According to an embodiment, based on the SSB, a user equipment may perform cell search, system information acquisition, beam alignment for initial access, and downlink (DL) measurement. According to an embodiment of the disclosure, SSB may also be referred to as a synchronization signal/physical broadcast channel (SS/PBCHSS/PBCH) block.

Referring to FIG. 3, an SSB may include a primary synchronization signal PSS, a secondary synchronization signal SSS, and a physical broadcast channel PBCH. Each of the signals PSS and SSS occupies a single OFDM symbol and a plurality of subcarriers, and PBCH spans across three OFDM symbols and the plurality of subcarriers although a single symbol may have a middle portion that is not used for SSS.

The PSS may serve as a reference signal for DL time/frequency synchronization and provide partial information of cell ID. The SSS may also serve as a reference signal for DL time/frequency synchronization and provide ID information of the remaining cells that is not provided by the PSS. In addition, the SSS may serve as a reference signal for demodulating the PBCH. The PBCH may carry a master information block MIB.

Polar coding may be used for the PBCH. The PBCH may indicate a frequency-multiplexed demodulation reference signal DMRS. For example, the PBCH may carry the frequency-multiplexed demodulation reference signal (DMRS), known as PBCH-DMRS.

In an example case in which user equipment is powered on or newly enters a cell, the user equipment may perform an initial cell search process. For example, the user equipment may perform synchronization with a base station. During the initial cell search process, the user equipment may receive the signals PSS and SSS to be synchronized with the base station and obtain information such as cell ID. Then, the user equipment may receive the PBCH from the base station and obtain MIB from the PBCH. The user equipment may receive a control resource set CORESET for receiving system information (which may correspond to remaining system information RMS or system information block 1 SIBI1) required for initial access, as well as configuration information for the control resource set CORESET and search space from the MIB. Each of the control resource set CORESET and the search space, configured as the MIB, may be considered to correspond to an identity ID of 0.

The user equipment may monitor a control resource set#0 CORESET#0 in an example case in which the DMRS transmitted in a selected SSB and the CORESET#0 is quasi-co-located (QCLed). The user equipment may receive SIB1 from the downlink control information transmitted in the CORESET#0. The user equipment may obtain configuration information related to random access channel RACH from the received SIB1. The user equipment may perform a random access procedure based on the configuration information related to RACH.

In the time domain, the SSB may include four OFDM symbols, and the PSS, SSS, PBCH, and PBCH-DMRS may be mapped to the symbols as illustrated in Table 1.

TABLE 1

| | OFDM symbol number l | Subcarrier number k |
|---|---|---|
| Channel | relative to the start of | relative to the start of |
| or signal | an SS/PBCH block | an SS/PBCH block |
| PSS | 0 | 56, 57, . . . , 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + v, 4 + v, 8 + v, . . . , |
| PBCH | | 236 + v |
| | 2 | 0 + v, 4 + v, 8 + v, . . . , 44 + v |
| | | 192 + v, 196 + v, . . . , 236 + v |

Referring to Table 1, PBCH-DMRS may have a mapping pattern varying depending on a variable ‘v.’ However, in a first symbol and a third symbol, PBCH-DMRS may be commonly mapped every four subscriber intervals on a frequency. The variable ‘v’ is defined as

$${N}_{ID}^{cell}$$

mod 4 (where

$${N}_{ID}^{cell}$$

is a physical cell ID). The variable ‘v’ is determined by taking a modulo-4 operation of the physical cell ID, so that the mapping pattern may vary depending on the physical cell ID.

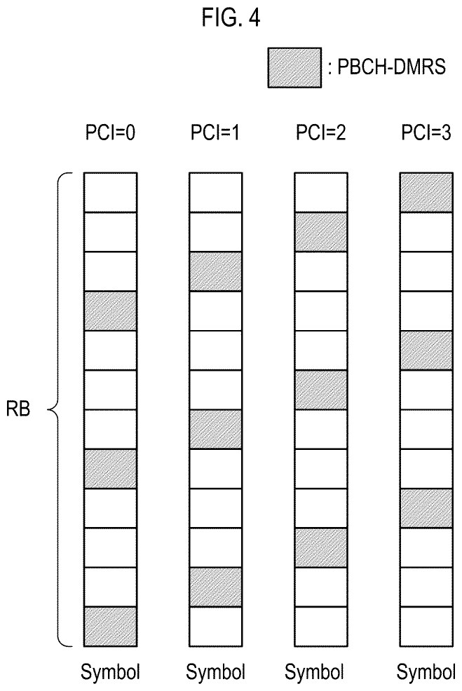

FIG. 4 is a diagram illustrating PBCH-DMRS mapping according to one or more example embodiments.

Referring to FIG. 4, there are three PBCH-DMRS per RB. For example, for a single OFDM symbol, there are three REs for PBCH-DMRS within a single RB. However, a mapping location may be shifted along a frequency axis depending on the physical cell ID (PCI).

In an example case in which physical cell ID (PCI) modulo-4 is equal to 0 (PCI=0), a value of ‘v’ is 0, which means that the PBCH-DMRS does not move from an original location (e.g., a location of a first RE within RB is a first subcarrier). In an example case in which the physical cell ID (PCI) modulo-4 is equal to 1 (PCI=1), the value of ‘v’ is 1, and as such, the PBCH-DMRS moves by a single RE on a frequency axis. In an example case in which the physical cell ID (PCI) modulo-4 is equal to 2 (PCI=2), the value of ‘v’ is 2, and as such, the PBCH-DMRS moves by two REs on the frequency axis. In an example case in which the physical cell ID (PCI) modulo-4 is equal to 3 (PCI=3), the value of ‘v’ is 3, and as such, the PBCH-DMRS moves three REs on the frequency axis. The RE shift of PBCH-DMRS is important for the user equipment to identify a correct physical cell ID during a cell search and synchronization process.

According to an embodiment, regardless of the physical cell ID (PCI), a distance between REs within an RB or between consecutive REs across RBs is 4 for PBCH-DMRS. However, the disclosure is not limited thereto, and as such, according to an embodiment, the number of PBCH-DMRS in an RB may be different than 3, and a distance between REs within an RB or between consecutive REs across RBs may be different than 4 for PBCH-DMRS.

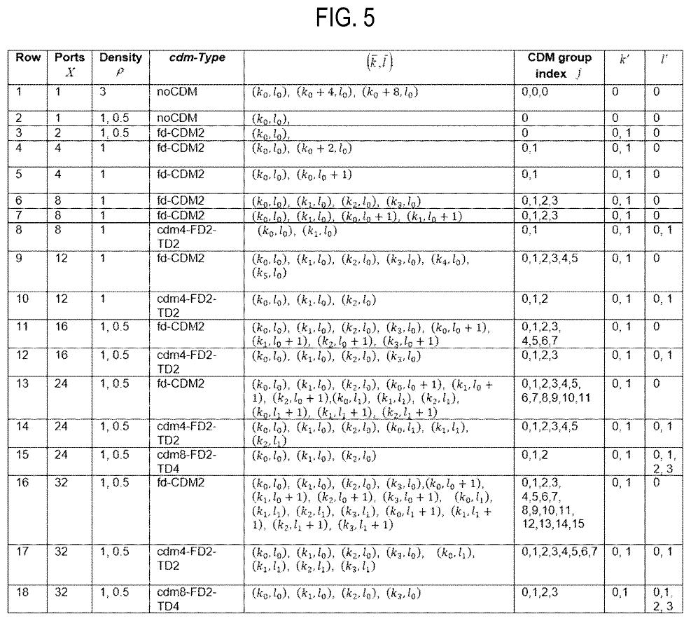

FIG. 5 is a diagram illustrating a channel state information reference signal (CSI-RS) mapping table according to one or more example embodiments.

CSI-RS is a reference signal for user equipment to report a channel state. A base station and the user element may transmit and receive signaling information NZP-CSI-RS-Resource to transfer information on CSI-RS resources. The signaling information NZP-CSI-RS-Resource may include information on each CSI-RS. The signaling information NZP-CSI-RS-Resource may include resourceMapping, mapping information of the CSI-RS resource. ResourceMapping may include frequency resource RE mapping, the number of antenna ports, symbol mapping, code division multiplexing (CMD) type, frequency resource density, and frequency band mapping information. The number of ports, frequency resource density, CDM type, and time-frequency RE mapping, which may be configured through resourceMapping, may correspond to a single row among rows of FIG. 5.

FIG. 5 illustrates frequency resource density p, CDM type, a starting position (k̅,l̅) of a CSI-RS RE pattern on frequency and time axes, and the number of REs k′ and the number of time axis REs 1′ of the CSI-RS RE pattern that may be set depending on the number of CSI-RS ports X. A CDM group index j may correspond to ((k̅,l̅) for a specific row of FIG. 5. The mapping of the time axis RE may be set by firstOFDMSymbolInTimeDomain included in the resourceMapping, and the mapping of the frequency axis RE may be set by frequencyDomainAllocation included in the resourceMapping.

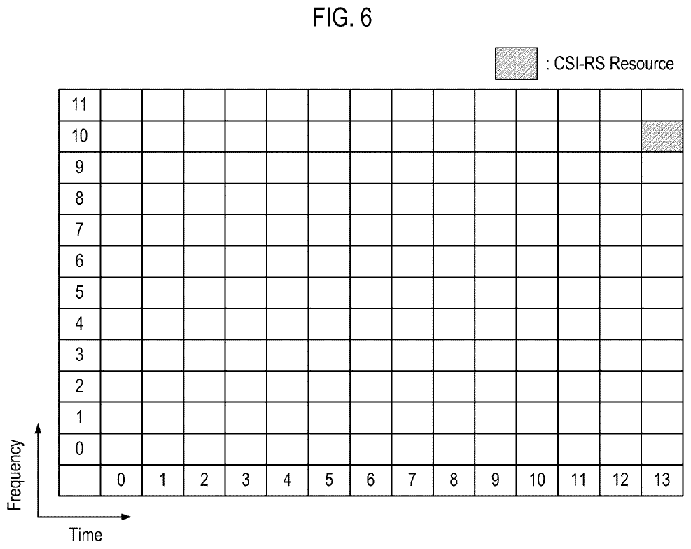

FIG. 6 is a diagram illustrating an CSI-RS RE mapping according to one or more example embodiments.

Referring to FIG. 6, in an example case in which the mapping-related information corresponds to row 2 of FIG. 5 based on signaling information, frequency resource density is 1, k₀ is 10, and l₀ is 13, a CSI-RS resource may be mapped to an 11^{th} subcarrier of a 14^{th} OFDM symbol. The frequency resource density is set to 1, so that a single CSI-RS resource may be mapped per RB. For example, a distance between CSI-RS REs across RBs may be 12.

FIG. 6 illustrates only an example of CSI-RS mapping, and CSI-RS resources may be mapped to various locations based on various parameters of FIG. 5, and the distance between CSI-RS REs may vary depending on the mapping location.

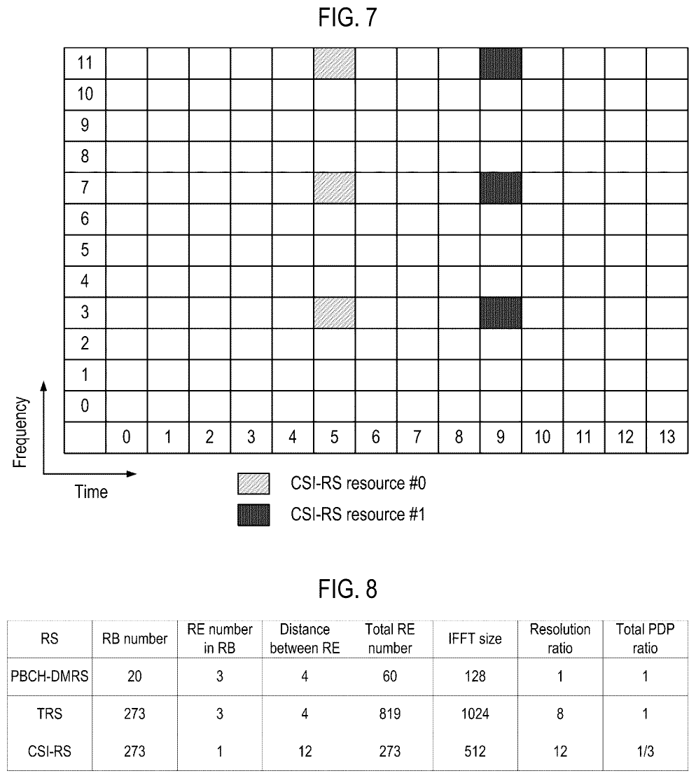

FIG. 7 is a diagram illustrating an RE pattern of a tracking reference signal (TRS) according to one or more example embodiments.

In an NR network, a tracking reference signal (TRS) is supported to track time/frequency of user equipment. TRS may be referred to as other terms such as “CSI-RS for tracking” in the standard, but will be used as it is for ease of description.

TRS refers to non-zero power (NZP) CSI-RS in which a repetition parameter of CSI-RS is not set and trs-Info is set to true.

Referring to FIG. 7, TRS may be mapped to a plurality of single-port CSI-RS resources having a frequency RE density of three REs per RB. Two single-port CSI-RS may be included in a single slot. For example, in a frequency band of 6 GHz or less defined as a frequency range 1 (FR1), TRS may be transmitted over two consecutive slots and a symbol pair, in which a CSI-RS resource may be located within each slot, may be one of {5^{th}, 9^{th}}, {6^{th}, 10^{th}}, and {7^{th}, 11^{th}}. For example, a single TRS transmission may include four CSI-RS resources over two consecutive slots.

According to an embodiment, in a frequency band of 6 GHz or less defined as a frequency range 2 (FR2), two or four CSI-RS resources may be provided. In FR2, a symbol pair that may be located within a single slot may be one of {1^{st}, 5^{th}}, {2^{nd}, 6^{th}}, {3^{rd}, 7^{th}}, {4^{th}, 8^{th}}, {5^{th}, 9^{th}}, {6^{th}, 10^{th}}, {7^{th}, 11^{th}}, {8^{th}, 12^{th}}, {9^{th}, 13^{th}}, and {10^{th}, 14^{th}}. For example, as illustrated in FIG. 7, CSI-RS resource#0 may be located at the 6^{th} symbol, and CSI-RS resource#1 may be located at the 10^{th} symbol. However, the symbol location of FIG. 7 is only an example of TRS resource mapping, and may vary depending on base station transmission.

Regardless of FR1 and FR2, a distance between REs within an RB or between consecutive REs across RBs is 4 for TRS. However, the disclosure is not limited thereto, and as such, according to another embodiment, the number of CSI-RS resources may be different than 2, and a distance between REs within an RB or between consecutive REs across RBs may be different than 4 for TRS.

Hereinafter, a description will be provided for example embodiments in which a user equipment merges power delay profiles (PDPs) of reference signals supported in a wireless communication system, including the above-described reference signals, into a merged PDP (MDPD), and the MDPD are used for channel estimation.

According to an embodiment of the disclosure, the power delay profile PDP may be include information related to the strength of a signal received through a multipath channel on a time axis. For example, the PDP may indicate the strength of a signal received through a multipath channel on a time axis. For example, the PDP may be a graph illustrating the strength of a signal received through a multipath channel on a time axis. For example, PDP represents strength of a signal as a function of time delay for a multipath channel. The time axis of PDP represents time delay, which indicates the time taken for multipath signals to reach a receiving side. The user equipment may estimate PDP from the received reference signal.

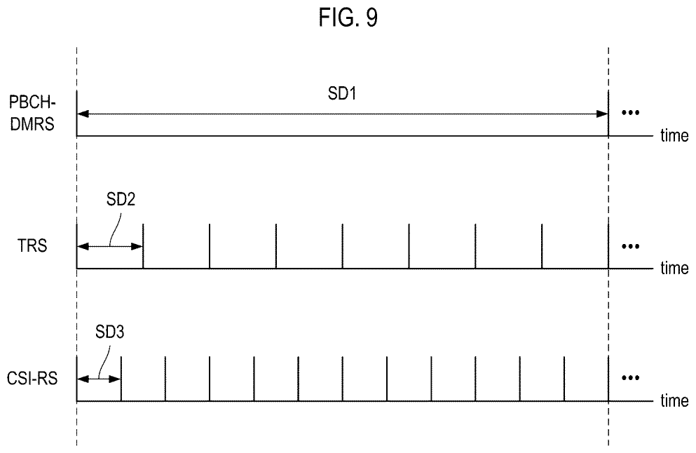

FIG. 8 is a diagram illustrating resource specifications of reference signals according to one or more example embodiments.

Referring to FIG. 8, resource specifications for reference signals are defined in a mobile communication environment according to one or more example embodiments. For example, the reference signals may include, but is not limited to, PBCH-DMRS, TRS, and CSI-RS. For example, the mobile communication environment may include, but is not limited to, 100 MHz bandwidth and 30 KHz subcarrier spacing. The number of RBs, the number of REs per RB, a distance between REs, the total number of REs, a size of inverse fast Fourier transform (IFFT), a sample resolution ratio, and a total PDP ratio, exemplarily defined (or set) in the above-mentioned environment, are illustrated for each reference signal.

In the case of PBCH-DMRS, 20 RBs are set in the above-mentioned environment and three PBCH-DMRS REs may be mapped in each RB. A distance between respective REs on the frequency axis may be 4. In an example case in which the number of RBs and the number of REs are taken into consideration, the total number of REs may be 60. In the case of TRS, 273 RBs may be set in the above-mentioned environment and three TRS REs may be mapped in each RB. A distance between respective REs on the frequency axis may be 4. In an example case in which the number of RBs and the number of REs are taken into consideration, the total number of REs may be 819. In the case of CSI-RS, 273 RBs may be set in the above-mentioned environment and one PBCH-DMRS RE may be mapped in each RB. A distance between respective REs on the frequency axis may be 12. In an example case in which the number of RBs and the number of REs are taken into consideration, the total number of REs may be 273.

According to one or more example embodiments, the user equipment may determine the IFFT size based on the total number of REs allocated to each reference signal. For example, the IFFT size illustrated in FIG. 8 may vary depending on the total number of REs. In LTE, a maximum size of IFFT may be set based on bandwidth. In NR, an IFFT size size may be up to 4096.

As described above, resource allocation specifications of the reference signals may be different from each other, so that a sample interval and a sample resolution on the time axis between respective reference signals may be different when sampling is performed through resources to which the reference signal is mapped. For example, depending on the mapping of the REs within an RB, sample intervals of the respective reference signals may be different from each other even when the same sampling size is set in a time domain.

According to an embodiment of the disclosure, the sample resolution ratio is a ratio defined for a sample of a first reference signal based on a sample for a second reference signal. Here, the second reference signal maybe an arbitrary reference signal. The sample resolution ratio may be defined as in the following Equation 1.

$$Resolution Ratio to PBCH\_DMRS = \frac{{r}^{dis ( Resource )} {N}_{IFFT}^{Resource}}{{r}^{dis ( PBCH - DMRS )} {N}_{IFFT}^{PBCH - DMRS}} \qquad Equation 1$$

Here, Resolution Ratio to PBCH-DMRS is a sample resolution ratio on a time axis for another reference signal with respect to PBCH-DMRS, r^{dis} is a distance between REs of a resource, and N is an IFFT size. r^{dis} is defined as

$$12 / {N}_{RE in RB}^{Resource} .$$

For example, r^{dis} is a value obtained by dividing 12 by the number of REs within an RB. Since denominators in Equation 1 are all values defined for PBCH-DMRS, r^{dis(PBCH-DMRS)} is a distance between REs of PBCH-DMRS on a frequency axis and

$${N}_{IFFT}^{PBCH - DMRS}$$

is an IFFT size for PBCH-DMRS. Numerators in Equation 1 are values defined for reference signals other than PBCH-DMRS.

Based on Equation 1, a sample resolution ratio of TRS to PBCH-DMRS is 8 times ((4×1024)/(4×128)) and a sample resolution ratio of CSI-RS to PBCH-DMRS is 12 times. For example, a sample interval of PBCH-DMRS on the time axis is 8 times the sample interval of TRS or 12 times the sample interval of CSI-RS. As a result, in an example case in which reference signals have different sample resolution ratios, the sample intervals and sample resolutions on the time axis may be different from each other.

In addition, in an example case in which the sample resolutions are different from each other, total PDP ratios may also be different from each other.

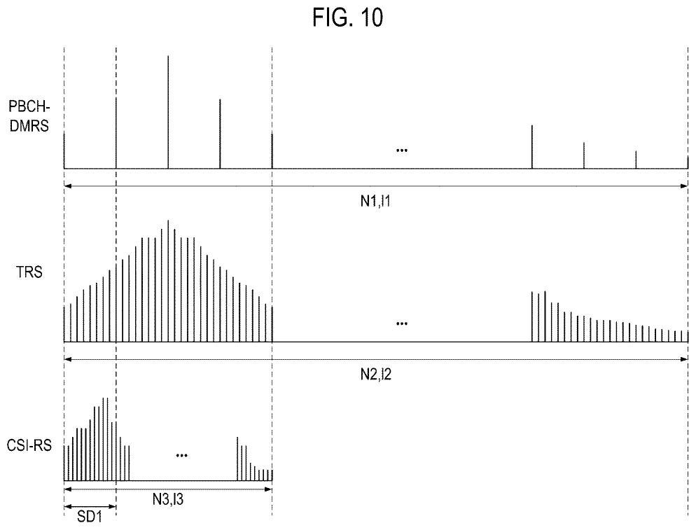

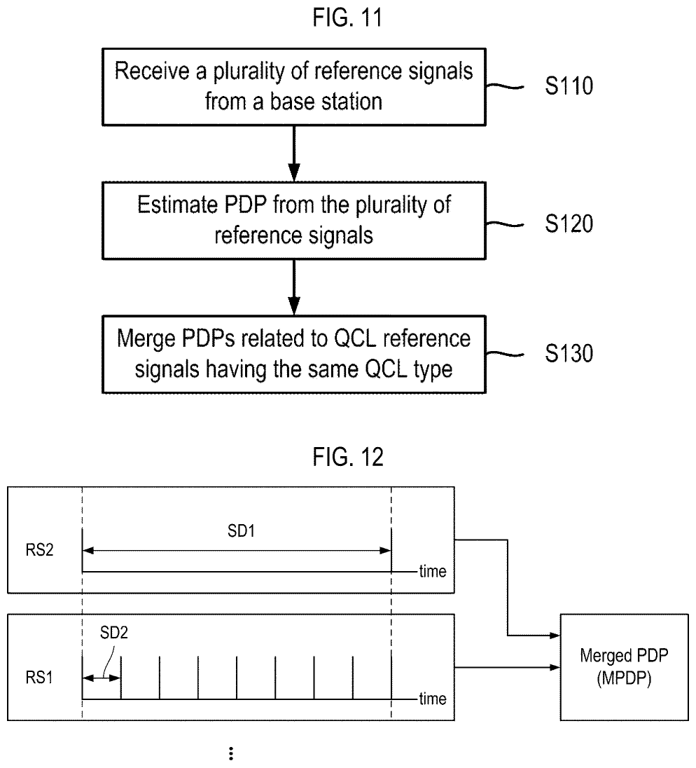

FIG. 9 is a diagram illustrating a comparison of sample resolutions between reference signal resources according to one or more example embodiments, and FIG. 10 is a diagram illustrating a comparison of overall power delay profile (PDP) ratios between reference signals according to one or more example embodiments. In FIG. 9, for ease of description, an example is provided in which all signals have the same strength.

Referring to FIG. 9, waveforms of reference signals transmitted from a base station to user equipment based on sampling and waveforms of reference signals delayed through multiple paths may be combined and then reach the user equipment, and the user equipment may estimate PDPs of the reference signals.

According to one or more example embodiments, sample resolutions of PBCH-DMRS, TRS, and CSI-RS PDPs on the time axis may be different from each other. For example, a PBCH-DMRS sample interval SD1 may be 8 times a time interval SD2 between TRS samples, or may be equal to 12 times a time interval SD3 between CSI-RS samples. For example, a time interval between samples is different for each reference signal. Accordingly, the number of samples in the same time interval (for example, sample resolution) may also be different. The difference in sample resolutions may result from the fact that the patterns and number of REs mapped on a resource grid are different for each reference signal and an IFFT size is different for each reference signal.

According to one or more example embodiments, in an example case in which reference signals are set with specifications different from those of FIG. 8, some reference signals may have the same sample resolution. For example, in a case in which the number of REs in an RB, a distance between REs, an IFFT size related to Equation 1, or the like, are different from those of FIG. 8, some reference signals may have the same sample resolution. Additional operations may not be required to combine the reference signals in a time domain. However, in an example case in which some reference signals have different sample resolutions as illustrated in FIG. 9, additional operations may be required to combine the reference signals in the time domain.

Referring to FIG. 10, a total length of PDP (for example, a time signal) for the reference signal may be relative due to different sample resolutions for each reference signal.

PBCH-DMRS and TRS have different IFFT sizes N1 and N2, resulting in a different number of samples within the same time interval. However, due to their different sample resolutions, the overall time interval lengths l1 and l2 of the PDP are the same.

PBCH-DMRS and CSI-RS have different IFFT sizes N1 and N3, resulting in a different number of samples within the same time interval (SD1). The overall time interval lengths l1 and l3 of the PDP are also different from each other. In an example case in which a sample resolution ratio of PBCH-DMRS and CSI-RS is 12, the sample interval SD1 of PBCH-DMRS may be 12 times the sample interval SD3 of CSI-RS.

Since N1=128 and N3=512, 11=3×13. Accordingly, the total PDP ratio of CSI-RS may be ⅓ as illustrated in FIG. 8.

As described with reference to in FIGS. 8, 9 and 10, the sample resolution and the total PDP ratio may be different between reference signals, and as such, the user equipment may take corresponding factors into consideration when merging PDPs. For example, the user equipment may merge PDPs based on a sample resolution and a total PDP ratio. For example, the user equipment may merge PDPs by taking into account an identify of the sample resolution and an identify of total PDP ratio. In addition, according to one or more example embodiments, QCL may be taken into consideration for PDP merging.

An antenna port is defined such that a channel, through which a symbol on the antenna port is carried, may be inferred from a channel through which another symbol on the same antenna port is carried. In an example case in which properties of the channel, through which a symbol on one antenna port is carried, may be inferred from the channel through which a symbol on another antenna port is carried, two antennas may be considered to be in a QCL relationship. For example, the properties may include, but is not limited to, large-scale properties. The large-scale properties may include, but is not limited to, one or more of delay spread, Doppler spread, Doppler shift, average gain, average delay, and spatial Rx parameters.

In the QCL relationship, a reference antenna port A (reference RS #A) and a target antenna port B (target RS #B) are quasi-co-located (QCLed), which means that the user equipment is allowed to apply at least a portion of the large-scale parameter estimated from antenna port A to channel measurement from antenna port B.

The user equipment may be set to a list of up to M TCI-State configurations (where TCI is a transmission configuration index in the PDSCH-Config), which is a higher-layer parameter, to decode a physical downlink shared channel (PDSCH) according to a detected physical downlink control channel (PDCCH) having intended downlink control information (DCI) for a corresponding user equipment and a given serving cell. M may depend on UE capability.

The QCL relationship may be set to the user equipment through TCI-State and QCL-Info as illustrated in Table 2.

TABLE 2

| | |
|---|---|
| TCI-State ::= | SEQUENCE { |
| tci-StateId | TCI-StateId, |
| qcl-Type1 | QCL-Info, |
| qcl-Type2 | QCL Info |
| ... | |
| { | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| ... | |
| { | |

Referring to Table 2, each TCI-State includes parameters for setting a QCL relationship between one or two downlink reference signals (DL RSs) and a DM-RS port of the PDSCH. The base station may set one or more TCI states to notify the user equipment of up to two QCL relationships (qcl-Type1 and qcl-Type2) for a reference signal, for example, a target RS, referring to an ID of the TCI state. Accordingly, the QCL relationship may be configured using a higher-layer parameter qcl-Type1 for a first DL RS, and qcl-Type2 for a second DL RS.

The QCL-Info included in TCI-State may include a serving cell index of a reference RS, a bandwidth part index (BWP), the type and ID of the reference RS, and qcl-Type. The QCL type corresponding to each DL RS is given by qcl-Type, and may take one of the following values (for example, properties):

```
  - ‘QCL-Type A’ : {Doppler shift, Doppler spread, average delay, delay
spread}
  - ‘QCL-Type B’ : {Doppler shift, Doppler spread}
  - ‘QCL-Type C’ : {Doppler shift, average delay}
  - ‘QCL-Type D’ : {Spatial Rx parameter}
```

In an example case in which a target port is a specific NZP CSI-RS, the NZP CSI-RS port may be indicated/set to be QCLed with a specific TRS in terms of QCL-Type A, and may be indicated/set to be QCLed with a specific SSB in terms of QCL-Type D. The user equipment may receive the NZP CSI-RS using the properties measured from the QCL-Type A TRS. Also, the user equipment may apply receive beam, used to receive the QCL-Type D SSB, to the reception of the NZP CSI-RS. In addition to the above example, the reference RS (for example, CSI-RS or SSB) and the target RS (for example, RS definable in NR) may be set to one of the types A to D, based on TCI-State and QCL-Info.

As described above, in an example case in which each reference signal corresponds to a QCL relationship based on TCI-State, the reference signals may be guaranteed a similar channel environment from the base station depending on the type of QCL type. For example, in the case of QCL-Type A, similar Doppler shift, Doppler spread, average delay, and delay spread may be guaranteed, so that the reference signals may be guaranteed a similar channel environment in a time domain. Accordingly, the reference signals defined by the QCL relationship may be considered to be merged in the time domain.

According to one or more example embodiments, the user equipment may be configured to perform merging when the reference signals correspond to QCL-Type A. Unlike other types, QCL-Type A may include delay spread as channel properties. The delay spread refers to a difference in arrival time between signals in multiple paths, and may indicate a signal range. Accordingly, in an example case in which reference signals correspond to QCL-Type A, the reference signals have similar ranges, and thus may be merged in the time domain.

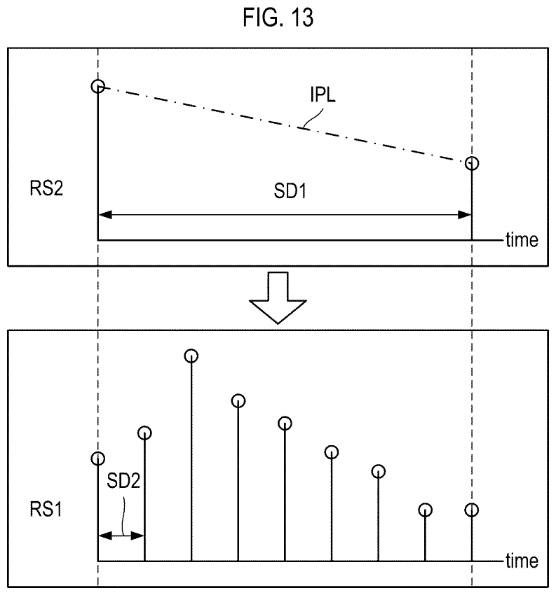

FIG. 11 is a flowchart illustrating a method according to one or more example embodiments. For example, the method may be performed by a user equipment.

Referring to FIG. 11, in operation S110, the method may include receiving a plurality of reference signals from a base station. For example, the user equipment may receive a plurality of reference signals from a base station. The plurality of reference signals may include at least one of PBCH-DMRS, TRS, and CSI-RS. However, the disclosure is not limited thereto. Each of the reference signals may be mapped to a specific RE on a resource grid, and the user equipment may receive the reference signal through the mapped RE.

In operation S120, the method may include estimating a PDP corresponding to each of the plurality of reference signals. For example, the user equipment may estimate the PDP from the plurality of reference signals. For example, the user equipment may estimate each of the PDPs based on information included in respective one of the plurality of reference signals. The user equipment may estimate the PDP from each of the received reference signals. Depending on a sample resolution ratio of the reference signals, a sample interval and a sample resolution of the estimated PDP may be the same or different. The sample resolution ratio may be defined based on Equation 1, so that the sample resolution ratio may be eventually changed depending on how the reference signal is mapped to the RE. For example, the estimated PDP may have the same sample interval and the same resolution, or different sample intervals and sample resolutions depending on how the RE mapping is set.

In operation S130, the method may include merging two of more of the PDPs. For example, the method may include obtaining a merged PDP (MPDP) by merging the two or more PDPs. For example, the user equipment may merge PDPs corresponding to at least two reference signals having a QCL relationship. Hereinafter, reference signals having a QCL relationship will be referred to as “at least two reference signals.” According to example embodiments, the user equipment may merge PDPs of reference signals having QCL Type-A. QCL Type-A may include Doppler shift, Doppler spread, average delay, and delay spread.

According to an embodiment of the disclosure, ‘merging’ of PDP may refer to merging another PDP into a reference PDP. In an example case in which the sample resolutions of the reference signals are the same, the user equipment may merge the PDPs immediately.

In an example case in which the sample resolutions of the reference signals are different from each other, the method proceeds to operation S130 in which the user equipment may merge a second reference signal having a relatively low sample resolution into a first reference signal having a relatively high sample resolution, based on the sample resolutions of at least two reference signals being different from each other. According to an embodiment, in operation S130, the user equipment may merge the first reference signal having a relatively high sample resolution into the second reference signal having a relatively low sample resolution based on the sample resolutions of at least two reference signals being different from each other.

According to the above-described embodiments, by merging PDPs of the plurality of reference signals, the user equipment may use the merged PDP to be synchronized with the base station or estimate a channel. In an example case in which the merged PDP of the plurality of reference signals are used, synchronization and channel estimation performance may be further improved. For example, the user equipment may improve the estimation performance to a channel, similar to a channel that the actual data experiences, through the merged PDP.

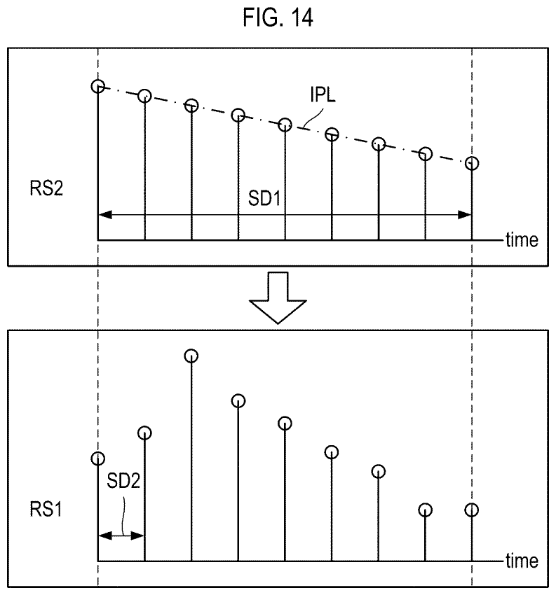

FIG. 12 is a diagram illustrating PDP merging according to one or more example embodiments.

Referring to FIG. 12, user equipment may merge PDPs of reference signals having different sample resolutions. According to one or more example embodiments, the user equipment may merge a PDP of a second reference signal RS2 having a relatively low sample resolution into a PDP of a first reference signal RS1 having a relatively high sample resolution, based on sample resolutions of at least two reference signals being different from each other. For example, the second reference signal RS2 may have sample resolution lower than the first reference signal RS1.

However, the disclosure is not limited thereto, and as such, according to another embodiment, the user equipment may merge the PDP of the first reference signal RS1 having a relatively high sample resolution into the PDP of the second reference signal RS2 having a relatively low sample resolution, based on the sample resolutions of at least two reference signals being different from each other. For example, the user equipment may merge PDPs of the first and second reference signals having relatively different sample resolutions, based on the sample resolutions of at least two reference signals being different from each other.

The merged PDP (MPDP) corresponding to the merging may be obtained by merging PDPs of a plurality of RSs on a time axis, and may be used for time synchronization or channel estimation of the user equipment. Although FIG. 12 illustrated one merged PDP (MPDP), the disclosure is not limited thereto, and as such, according to an embodiment, a plurality of MPDPs may be obtained by merging different sets of reference signals RSs.

According to one or more example embodiments, the user equipment may check the QCL type of the received reference signals. The user equipment may merge PDPs of a plurality of reference signals identified as having a QCL relationship with the same QCL type. For example, the QCL type for the PDP merging condition may be QCL-Type A. For example, the user equipment may merge PDPs of reference signals having the same Doppler shift, Doppler spread, average delay, and delay spread properties as defined by the QCL-Type A relationship.

In an example case in which the reference signals have the same sample resolution and are in a QCL relationship with the same QCL type, the user equipment may merge the PDPs of the reference signals. In another example case in which the reference signals have the same QCL type but different sample resolutions, the user equipment may perform an operation of adjusting a sample resolution of other reference signals on a sample resolution of the reference signal that is a standard for merging.

According to one or more example embodiments, based on the total PDPs being different between the reference signals, the user equipment may adjust the total time length of the PDP of another reference signal based on the total time length of the PDP of a single reference signal.

According to one or more example embodiments, based on the total PDPs are different between the reference signals, the user equipment may merge a PDP corresponding to the reference signal having a relatively small total time length into a PDP corresponding to the reference signal having a relatively large total time length. Starting points on the time axis of the merged PDPs may be aligned to be the same.

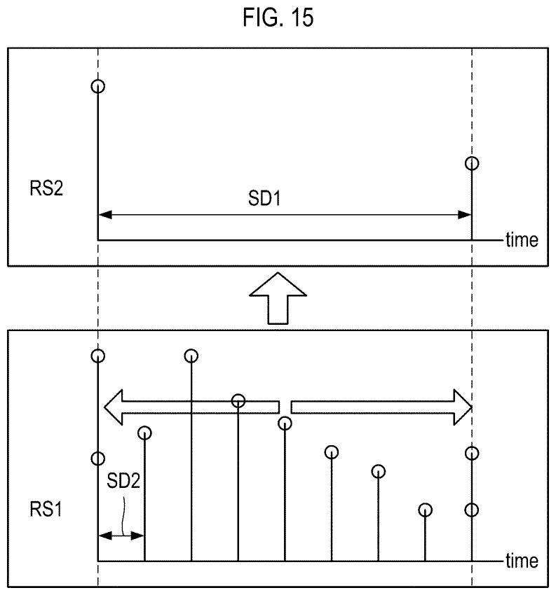

FIGS. 13 to 15 are diagram illustrating an example of the PDP merging of FIG. 12.

FIGS. 13 to 15 illustrate an operation of user equipment merging reference signals having different sample resolutions.

Referring to FIG. 13, according to one or more example embodiments, a user equipment may calculate a representative value of a first reference signal RS1 (or a second reference signal RS2) through interpolation. For example, the representative value may be an average as a value representing a QCL reference signal interpolated through interpolation IPL.

Based on the calculated representative value, the user equipment may merge the PDP of one of the first reference signal RSI and the second reference signal RS2 into the PDP of the other of the first reference signal RS1 and the second reference signal RS2. In an example, case, the user equipment may merge the PDP of the first reference signal RS1 into the PDP of the second reference signal RS2. In another example case, the user equipment may merge the PDP of the second reference signal RS2 into the PDP of the first reference signal RS1. For example, the user equipment may add the calculated representative value to each sample of the other QCL reference signal. Then, the merged PDP may show a form in which the representative value of the first reference signal RS1 is added to signal strength of each sample of the second reference signal RS2.

Referring to FIG. 14, user equipment according to an example embodiment may merge a PDP of a second reference signal RS2 into a PDP of a first reference signal RS1 through upsampling. The upsampling may allow a sample resolution of the second reference signal RS2 to be the same as a sample resolution of the first reference signal RS1. Then, the merged PDP may be the sum of strength of the upsampled second reference signal RS2 and strength of the first reference signal RS1.

For example, the user equipment may merge each sample of the upsampled second reference signal RS2 into each sample of the first reference signal RS1 through interpolation.

Referring to FIG. 15, according to one or more example embodiments, a user equipment may merge a PDP of a first reference signal RS1 into a PDP of a second reference signal RS2 through downsampling. The downsampling may allow a sample resolution of the first reference signal RS1 to be the same as a sample resolution of the second reference signal RS2. Then, the merged PDP may be the sum of strength of the downsampled first reference signal RS1 and strength of the second reference signal RS2.

The above-described embodiments are merely exemplary, and the user equipment may perform various operations of adjusting a sample resolution to merge PDPs of reference signals having different sample resolutions into a single PDP.

In the above-described embodiments, a difference in sample resolution refers to a difference in different sample resolution ratios of Equation 1, so that the merging of PDPs may also be considered to merge reference signals having different sample resolution ratios. A sample resolution ratio of at least two reference signals may be defined as a ratio of the product of a distance between REs on a frequency axis and an IFFT size of an arbitrary first reference signal to the product of the distance between REs on the frequency axis and the IFFT size of the second reference signal, based on Equation 1.

The user equipment may unify the sample resolution ratios, based on the sample resolution ratios of at least two reference signals being different from each other. The sample resolution ratio serving as a standard for unification may be a sample resolution ratio of one of the QCL reference signals among at least two reference signals. The user equipment may merge the PDP of the first reference signal and the PDP of the second reference signal based on the unified sample resolution ratio.

In the above-described embodiments, at least one QCL reference signal may be a signal received first by the user equipment. Nevertheless, in an example case in which a PDP of the QCL reference signal received first is merged with a PDP of another previously estimated QCL reference signal, a PDP corresponding to an average channel for a certain period of time may be expected to be generated.

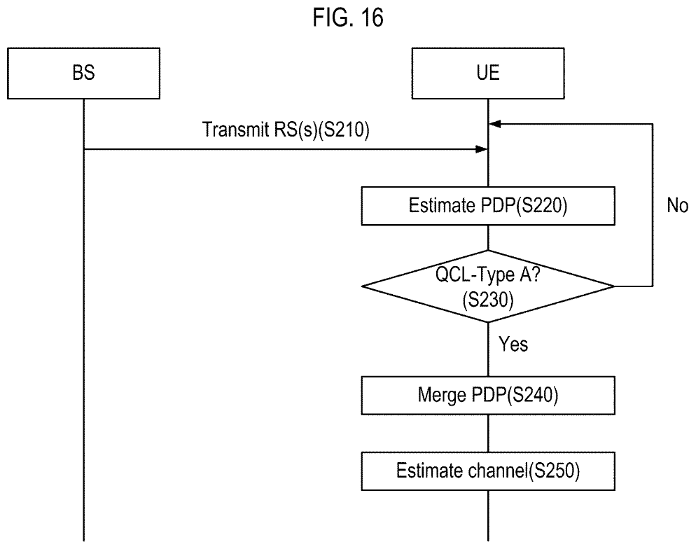

FIG. 16 is a flowchart illustrating a method of operating a wireless communication system according to one or more example embodiments.

Referring to FIG. 16, in operation S210, a base station included in a wireless communication system may transmit a plurality of reference signals to am user equipment. For example, the plurality of reference signals may include at least one of PBCH-DMRS, TRS, and CSI-RS. However, the disclosure is not limited thereto, and as such, according to another embodiment, the plurality of reference signals may include various reference signals supported in NR. For example, the plurality of reference signals may include, but is not limited to, PDSCH DMRS, physical uplink shared channel (PUSCH) DMRS, PDCCH DMRS, physical uplink control channel (PUCCH) DMRS, sounding reference signal (SRS), and phase tracking reference signal (PTRS).

Each reference signal may be transmitted at a position indicated/set on the resource grid.

In operation S220, am user equipment may estimate a PDP corresponding to each of a plurality of received reference signals. For example, the user equipment may estimate each of the PDP from a respective one of the plurality of received reference signals. The PDP may be estimated from each of the received reference signals. Depending on how specifications of each reference signal (for example, the number of REs within an RB in FIG. 7, a distance between REs, a IFFT size, or the like) are set, a sample resolution of the estimated PDP on a time axis may be the same or different.

In operation S230, the user equipment may check whether there are at least two reference signals in a QCL relationship (for example, QCL-Type A) among the plurality of received reference signals. According to one or more example embodiments, the user equipment may receive a configuration of the QCL type through radio source control (RRC) signaling (for example, TCI-State and QCL-Info). Based on the configured TCI-State (see Table 2), the user equipment may check whether the reference signals are in a QCL relationship of the same QCL type. In an example case in which the QCL types are different, the user equipment may repeat operation S210 to S230. However, the disclosure is not limited thereto, and as such, even in an example case in which the QCL types are the same but not a defined type (for example, QCL-Type A), the user equipment may repeat operation S210 to S230.

In an example case in which the reference signals are in a QCL relationship with the same defined QCL type, the method proceeds to operation S240 in which the user equipment may merge the estimated PDPs. In an example case in which merging the estimated PDPs, the user equipment may take the sample resolution and the total time length of the PDP into consideration.

In operation S250, the user equipment may estimate a channel between the base station and the user equipment based on the merged PDP corresponding to the merging. According to one or more example embodiments, the estimated channel may be used for time synchronization or signal demodulation. For example, the user equipment may demodulate data symbols based on the channel estimated from the merged PDP, or use the estimated channel for time synchronization with the base station.

According to the above-described embodiments, the user equipment may improve channel estimation performance by merging PDPs between at least two reference signals having various channel properties, including delay spread, are ensured to be the same (or similar), and estimating the channel based on the merged PDP.

In addition, even in an example case in which there are reference signals ensured to not always be transmitted, the user equipment may merge PDPs of the received reference signals to supplement the channel estimation performance.

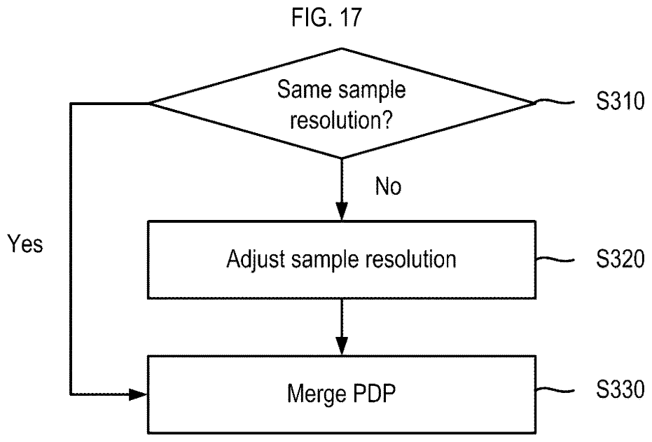

FIG. 17 is a flowchart illustrating a method of operating user equipment according to one or more example embodiments.

Referring to FIG. 17, in operation S310, user equipment may check whether at least two reference signals to be merged have the same sample resolution. The sample resolution may be the same or different depending on a sample resolution ratio defined based on Equation 1.

In an example case in which sample resolution ratios of at least two reference signals are different, the method proceeds to operation S320 in which user equipment may adjust a sample resolution ratio of at least a portion of the at least two reference signals, based on the sample resolution ratios of the at least two reference signals being different. The adjustment of the sample resolution ratio may be performed according to the above-described embodiments (for example, FIGS. 12 to 15). For example, the adjusting the sample resolution ratio may refer to matching a sample resolution ratio (or a sample resolution) of one QCL reference signal with a sample resolution ratio (or a sample resolution) of the remaining QCL reference signals.

In operation S330, the user equipment may merge PDPs of the at least two reference signals based on the adjusted sample resolution ratio. In an example case in which the sample resolution ratios are the same in operation S310, the user equipment may immediately perform operation S330.

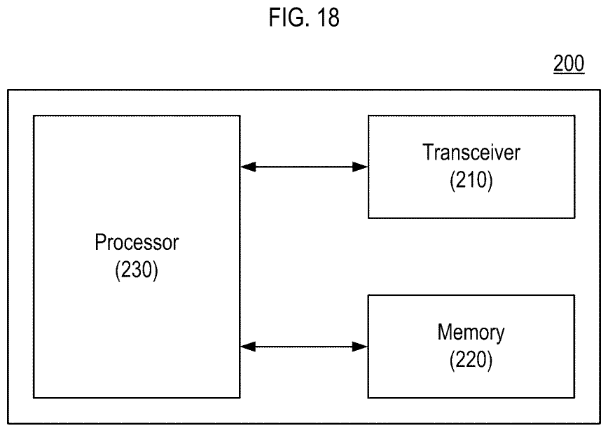

FIG. 18 is a block diagram of a device according to one or more example embodiments. For example, the device may be user equipment connected to a base station through a channel.

Referring to FIG. 18, a device 200 may include a transceiver 210, a memory 220, and a processor 230. However, components of the device 200 are not limited to the above-described examples. For example, the device 200 may include more or fewer components than the above-described components. Furthermore, at least a portion or all of the transceiver 210, memory 220, and processor 230 may be implemented in the form of a single chip.

In example embodiments, the transceiver 210 may transmit signals to a base station and may receive signals from the base station. The transmitted signals and the received signals may include control information and data. According to one or more example embodiments, the transceiver 210 may include a radio-frequency (RF) transmitter and an RF receiver. The RF transmitter may be configured to up-convert and/or amplify a frequency of a transmitted signal, and the RF receiver may be configured to amplify a received signal with low noise and/or down-convert a frequency of the amplified signal. In addition, the transceiver 210 may receive a signal through a wireless channel and output the received signal to the processor 230 and transmit the signal, output from the processor 230, through a wireless channel.

The memory 220 may be provided in singular or plural to be connected to the processor 230, and may store various types of information related to the operation of the processor 230. For example, the memory 220 may store software code including at least one instruction for performing a portion or all of the processes controlled by the processor 230 or performing descriptions, functions, procedures, proposals, methods, and/or operation flowcharts of the disclosure.

The processor 230 may be provided in singular or plural to control the memory 220, and may execute at least one instruction, stored in the memory 220, to implement descriptions, functions, procedures, proposals, methods, and/or operation flowcharts of the disclosure. In addition, the processor 230 may provide various operations according to various embodiments based on instructions stored in the memory 220. Furthermore, the processor 230 may process information, stored in the memory 220, to generate data.

According to one or more example embodiments, the processor 230 may execute at least one instruction to receive a plurality of reference signals from a base station through the transceiver, estimate a PDP from the plurality of reference signals, and merge PDPs corresponding to at least two reference signals in a QCL relationship, among the plurality of reference signals.

According to the above-described embodiments, the device 200 may improve channel estimation performance by merging PDPs between at least two reference signals having various channel properties, including delay spread, are ensured to be the same (or similar), and estimating the channel based on the merged PDP.

As set forth above, according to one or more example embodiments, PDP merging method and device for merging a power delay profile of reference signals may be provided.

While example embodiments have been shown and described above, it will be apparent to those skilled in the art that modifications and variations could be made without departing from the scope of the present inventive concept as defined by the appended claims.

What is claimed is:

1. A method performed by a user equipment in a wireless communication system, the method comprising:
receiving a plurality of reference signals from a base station;
estimating a plurality of power delay profiles (PDPs), each of the plurality of PDPs respectively corresponding to one of the plurality of reference signals; and
obtaining a merged PDP by merging at least two PDPs, among the plurality of PDPs, the at least two PDPs corresponding to at least two reference signals, having a quasi-co-location (QCL) relationship, among the plurality of reference signals.

2. The method of claim 1, wherein the QCL relationship is defined as QCL-Type A.

3. The method of claim 2, wherein the QCL Type-A comprises Doppler shift, Doppler spread, average delay, and delay spread.

4. The method of claim 1, further comprising:
estimating a channel between the base station and the user equipment based on the merged PDP.

5. The method of claim 1, wherein the obtaining the merged PDPs comprises merging a first PDP of a first reference signal, among the at least two reference signals, into a second PDP of a second reference signal, among the at least two reference signals, and
wherein the first reference signal has a lower sample resolution than the second reference signal.

6. The method of claim 1, wherein the obtaining the merged PDPs comprises merging a first PDP of a first reference signal, among the at least two reference signals, into a second PDP of a second reference signal, among the at least two reference signals, and
wherein the first reference signal has a higher sample resolution than the second reference signal.

7. The method of claim 1, wherein the plurality of reference signals comprise at least one of a physical broadcast channel-demodulation reference signal (PBCH-DMRS), a tracking reference signal (TRS), and a channel state information reference signal (CSI-RS).

8. The method of claim 1, wherein
a sample resolution ratio of the at least two reference signals is defined as a ratio of a product of a distance between resource elements (REs) on a frequency axis of a first reference signal and an inverse fast Fourier (IFFT) size to a product of a distance between REs on a frequency axis of a second reference signal and an IFFT size.

9. The method of claim 8, wherein
the merging the PDPs comprises:
unifying the sample resolution ratios based on the sample resolution ratios of the at least two reference signals being different from each other; and
merging a PDP of the first reference signal and a PDP of the second reference signal based on the unified sample resolution ratio.

10. The method of claim 1, wherein the QCL relationship is configured based on radio resource control (RRC) signaling.

11. A device of a wireless communication system, the device comprising:
at least one transceiver;
at least one processor electrically connected to the at least one transceiver; and
a memory electrically connected to the at least one processor and configured to store at least one instruction,
wherein, the at least one instruction is configured to control the device to:
receive a plurality of reference signals from a base station through the at least one transceiver;
estimate a plurality of power delay profiles (PDPs), each of the plurality of PDPs respectively corresponding to one of the plurality of reference signals; and
obtain a merged PDP by merging at least two PDPs, among the plurality of PDPs, the at least two PDPs corresponding to at least two reference signals, having a quasi-co-location (QCL) relationship, among the plurality of reference signals.

12. The device of claim 11, wherein the QCL relationship is defined as QCL-Type A.

13. The device of claim 12, wherein the QCL Type-A comprises Doppler shift, Doppler spread, average delay, and delay spread.

14. The device of claim 11, wherein the at least one processor is configured to execute the at least one instruction to estimate a channel between the base station and the device based on the merged PDPs.

15. The device of claim 11, wherein, the at least one instruction is configured to control the device to merge a first PDP of a first reference signal, among the at least two reference signals, into a second PDP of a second reference signal, among the at least two reference signals, and
wherein the first reference signal and the second reference signal have different sampling resolutions.

16. The device of claim 11, wherein the at least one instruction is configured to control the device to:
a sample resolution ratio of the at least two reference signals is defined as a ratio of a product of a distance between resource elements (REs) on a frequency axis of a first reference signal and an inverse fast Fourier (IFFT) size to a product of a distance between REs on a frequency axis of a second reference signal and an IFFT size.

17. The device of claim 16, wherein the at least one instruction is configured to control the device to:
unify the sample resolution ratio based on the sample resolution ratios of the at least two reference signals are being different from each other; and
merge a PDP of the first reference signal and a PDP of the second reference signal based on the unified sample resolution ratio.

18. A wireless communication device, the device comprising:
at least one transceiver;
at least one processor electrically connected to the at least one transceiver; and
a memory electrically connected to the at least one processor and configured to store at least one instruction,
wherein, the at least one instruction is configured to control the device to:
receive a plurality of reference signals from a base station through the at least one transceiver;
estimate a plurality of power delay profiles (PDPs), each of the plurality of PDPs respectively corresponding to one of the plurality of reference signals; and
obtaining a merged PDP by merging at least two PDPs, among the plurality of PDPs, at least two PDPs corresponding to at least two reference signals, having a quasi-co-location (QCL) relationship, among the plurality of reference signals, and
wherein the merging the PDPs comprises adjusting a sample resolution ratio of at least a portion of the least two reference signals based on sample resolution ratios of the at least two reference signals being different from each other.

19. The device of claim 18, wherein the QCL relationship is defined as QCL-Type A.

20. The device of claim 18, wherein the sample resolution ratio is defined as a ratio of a product of a distance between resource elements (REs) on a frequency axis of a first reference signal and an inverse fast Fourier (IFFT) size to a product of a distance between REs on a frequency axis of a second reference signal and an IFFT size.
